(19) United States
(12) Patent Application Publication
(10) Pub. No.: US 2014/0270705 A1
(43) Pub. Date: Sep. 18, 2014

(54) REFORMATTING MEDIA STREAMS TO INCLUDE AUXILIARY DATA

(71) Applicant: Verimatrix, Inc., San Diego, CA (US)

(72) Inventors: Alexander Solonsky, San Diego, CA (US); Andreas Eleftheirou, San Diego, CA (US); Niels Thorwirth, San Diego, CA (US)

(73) Assignee: Verimatrix, Inc., San Diego, CA (US)

(21) Appl. No.: 14/213,919

(22) Filed: Mar. 14, 2014

Related U.S. Application Data
(60) Provisional application No. 61/798,134, filed on Mar. 15, 2013.

(51) Int. Cl. H04N 19/467; H04N 21/2347; H04N 19/154; H04N 19/176; H04N 19/40; H04N 19/13

(52) U.S. Cl. CPC H04N 19/00557; H04N 19/00472; H04N 19/00121; H04N 19/002; H04N 19/00278; H04N 21/2347
USPC 386/252

(57) ABSTRACT

Reformatting a media stream to include auxiliary data, the method including: receiving the auxiliary data to be inserted into the media stream; determining the amount of data in the auxiliary data; identifying media data in the media stream to be reduced in size; reformatting the media stream to reduce the amount of data in the media data such that the amount of data removed from the media data is at least equal to the amount of data in the auxiliary data while providing minimal impact to the quality of the media data; and adding the auxiliary data to the media stream which maintains a consistent size.

### CROSS-REFERENCE TO RELATED APPLICATIONS

This application claims the benefit of priority under 35 U.S.C. §119(e) of co-pending U.S. Provisional Patent Application No. 61/798,134, filed Mar. 15, 2013, entitled “Systems and Methods for Reformatting of media streams to include auxiliary data”. The disclosure of the above-referenced application is incorporated herein by reference.

### BACKGROUND

1. Field of the Invention

The present invention relates to media streams, and more specifically, to reformatting media streams to include auxiliary data.

2. Background

The encoding of content into media streams needs to satisfy multiple conditions. For example, the content needs to be compressed to a small size for efficient transmission. The content also needs to conform to specifications that allow for multiple different client devices to decode and present the content in a consistent manner. Further, it needs to provide high level information that allows for parsing, trickplay and navigation of the content. Frequently, it also needs to allow for time synchronization so that the client device is playing at the same rate that the server is delivering the media content.

The above-listed complexities are layered and have interdependencies between them. Modification of the content size often results in invalidation of other components, possibly with circular implications. However, to enhance the usefulness or protection of the content, there are instances where information needs to be added to an encoded media stream.

One common situation includes the need to add digital rights management (DRM) related information, such as conditional access (CA) entitlement control messages (ECM) and entitlement management messages (EMM), to an existing media stream to protect the stream after it has been encoded. A simple insertion of additional information in the existing content format would displace the location of following information, increase the bit rate used to transmit the content, and disrupt the overall consistency that can be used for timing during streaming and playback. Correction of these interdependent parameters can be accomplished with a content transcode. In the content transcode process, the original stream is broken down into elementary components, audio, video, and so on. At this level, information is added or removed, and the process of multiplexing is then applied to create a new stream that includes audio and video with the correct timing information. However, this is complex and time intensive, and therefore often uses dedicated and expensive hardware to perform the task within acceptable processing delays that are in particular relevant for live streaming. If the inconsistencies are not remedied, the content playback is likely affected negatively with artifacts such as jitter, skips, or frozen playback.

### SUMMARY

Systems and methods for reformatting of media streams to include auxiliary data are provided. In one embodiment, media data in the media stream can be identified and removed in an efficient and fast manner, with minimal and imperceptible quality loss, to allow for insertion of auxiliary information without disruption of the media stream consistency. In another embodiment, proper PCR values are maintained for the media stream. Benefits of these embodiments include, for example, providing a lightweight process that can be applied in real time in software that has a very limited view of the stream and can therefore be applied with small delay to the video processing workflow. Further, eliminating the frequencies that are expensive to the data compression can result in a reduction in data with minimal amount of visual degradation.

In one aspect, a method to reformat a media stream to include auxiliary data is disclosed. The method includes: receiving the auxiliary data to be inserted into the media stream; determining the amount of data in the auxiliary data; identifying media data in the media stream to be reduced in size; reformatting the media stream to reduce the amount of data in the media data such that the amount of data removed from the media data is at least equal to the amount of data in the auxiliary data while providing minimal impact to the quality of the media data; and adding the auxiliary data to the media stream.

In another aspect, a system for reformatting a media stream to include auxiliary data is disclosed. The system includes: a head end server configured to receive the auxiliary data to be inserted into the media stream through a first network, the head end server determining the amount of data in the auxiliary data, identifying media data to be reduced in size in the media stream, and reformatting the media stream to reduce the amount of data in the media data such that the amount of data removed from the media data is at least equal the amount of data in the auxiliary data while providing minimal impact to the quality of the media data; and a network interface module configured to add the auxiliary data to the reformatted media stream and distribute the media stream to a plurality of client devices through a second network while the media stream maintains a consistent size.

In yet another aspect, a non-transitory storage medium storing a computer program to reformat a media stream to include auxiliary data is disclosed. The computer program comprising executable instructions that cause the computer to: receive the auxiliary data to be inserted into the media stream; determine the amount of data in the auxiliary data; identify media data to be reduced in size; reformat the media stream to reduce the amount of data in the media data such that the amount of data removed from the media data is at least equal to the amount of data in the auxiliary data while providing minimal impact to the quality of the media data; and add the auxiliary data to the media stream.

Other features and advantages of the present invention should be apparent from the present description which illustrates, by way of example, aspects of the invention.

### BRIEF DESCRIPTION OF THE DRAWINGS

The details of the present invention, both as to its structure and operation, may be gleaned in part by study of the appended further drawings, in which like reference numerals refer to like parts, and in which:

FIG. 1 is an overview of a content access or conditional access (CA) implementation which illustrates the problem of adding information to media streams;

FIG. 2 illustrates a PCR correction showing the location of blocks with newly added data (New Data1 and New Data2) and the accumulated PCR adjustment in two locations;

FIG. 3 is a functional block diagram of a system for reformatting selected locations of media data to make room in the data section that allows for insertion of auxiliary data without increase in the file size and bit rate;

FIG. 4 is a flow diagram illustrating a process of adding auxiliary data to a media stream in accordance with one embodiment of the present invention; and

FIG. 5 is a flow diagram illustrating a process that shows the details of the identification process and the reformatting process in accordance with one embodiment of the present invention.

### DETAILED DESCRIPTION

As described above, modification of the content size often results in invalidation of other components, possibly with circular implications. However, to enhance the usefulness or protection of the content, information needs to be added to the media stream.

Certain embodiments as disclosed herein provide for avoiding drawbacks of inserting information to the media stream by reformatting media stream to include auxiliary data. After reading the below description it will become apparent how to implement the invention in various embodiments and applications. However, although various embodiments of the present invention will be described herein, it is understood that these embodiments are presented by way of example only, and not limitation. As such, this detailed description of various embodiments should not be construed to limit the scope or breadth of the present invention.

In one embodiment, media streams are files that contain digital media such as audio or video or combinations thereof. A media stream may include several streams of audio, video, and text in different tracks. The individual tracks may be included in a program stream like MPEG program stream (MPEG-PS). Different tracks may include different video programs or alternative audio tracks for different languages or text for subtitles. Content is typically compressed for efficient transmission and storage using codes like MPEG2, AVC or HEVC. Media streams can be provided as files for download by a client device or streamed such that the client device will not have access to the entire content before the playback begins but receives the content just before playback. Streaming may be applied to content prepared in advance or live, in a continuous process while recording.

Auxiliary data is information that enhances media streams by adding information, for example, used to aid in content decryption such as digital rights management (DRM) information. Other examples of auxiliary data include sub titles, information for a video decoder or video renderer, thumbnails that can be displayed with the content, Internet links to websites with related information and additional audio tracks.

Media data encodes perceptual information, and is included in the media stream. Examples include video frames, video slices, prediction information, macroblocks, and motion vectors. Media data is not limited to video, and can be, for example, audio or other content data.

Conditional access (CA) is a DRM technology that provides protection of content by requiring certain criteria to be met before granting access to the content. This can be achieved by a combination of scrambling and encryption. The data stream is scrambled with a secret key referred to as the control word. Knowing the value of a single control word at a given moment is of relatively little value, because content providers will change the control word several times per minute. The control word is generated automatically in such a way that successive values are not usually predictable. In order for the receiver to descramble the stream, it must be authorized first and informed by the CA unit ahead of time. Typically, entitlement messages are used by a CA unit to authorize and communicate the decryption keys to the receiver of the stream.

FIG. 1 is a functional block diagram of a content access or conditional access (CA) implementation 100 which illustrates the process of adding information to media streams with a specific example of a Moving Picture Experts Group 2 (MPEG-2) transport stream in digital video broadcast (DVB) format. CA Module 110 inserts information into the media stream via content encryption/distribution unit 120. The CA client module present, for example, in the subscriber's Set-Top Box (STB) 130 uses this information to determine if the end-user has sufficient digital rights to decrypt and view that media stream. CA specific information is encapsulated in the media stream as either an Entitlement Control Message (ECM) or an Entitlement Management Message (EMM). While ECMs are used to transmit the digital keys necessary to decrypt the media stream, EMMs are used to authorize an STB or a group of STBs to decrypt the media stream.

In the MPEG transport stream, to enable a decoder to present synchronized content (e.g., audio tracks matching the associated video), a Program Clock Reference (PCR) is transmitted in the adaptation field of an MPEG-2 transport stream packet on an arbitrary basis, but no less than every 0.1 seconds. The PCR packet includes a PCR time base consisting of 48 bits (six bytes), which define a time stamp. The time stamp indicates the relative time that the PCR packet was sent by the program source. The value of the PCR, when properly used, is employed to generate a system_timing_clock in the decoder. The PCR packets have headers and a flag to enable their recovery at the receiver, for example, a set top box (STB), where they are used to synchronize the receiver clock to the source clock. The System Time Clock (STC) decoder, when properly implemented, provides a highly accurate time base that is used to synchronize audio and video elementary streams. Timing in MPEG-2 references this clock. For example, the presentation time stamp (PTS) is intended to be relative to the PCR. The first 33 bits are based on a 90 kHz clock. The last 9 are based on a 27 MHz clock. A standard maximum jitter permitted for the PCR is ±500 ns.

The size of a media stream for a given duration is termed bit rate and it is expressed as the amount of data between two consecutive recordings of the PCR in the stream. When inserting or removing information from a media stream, it is therefore necessary to correct the PCR value of all successive PCR recordings to reflect the change of the amount of data. This action of adjusting all successive PCR values is called a PCR correction.

FIG. 2 illustrates the PCR correction showing the location of blocks with newly added data (New Data1 and New Data2) and the accumulated PCR adjustment in two locations. This method of adjusting the PCR values, can achieve relatively high levels of throughput without the use of specialized hardware but it is prone to errors and its accuracy can be affected by the bit rate characteristics of the original stream. Inserting CA information in the media stream (in the form of ECM and EMM messages) is a relatively simple process. However, when the data is inserted, difficulty arises from the fact that the additional data causes the above mentioned inconsistencies. Because the amount of data present between two consecutive PCR values changes when inserting new data, such as ECM and EMMs, all such PCR values should be recalculated in order to maintain the validity of the stream bit rate. If PCR values are not adjusted, the resulting stream will be incoherent.

One approach to applying the PCR correction involves modules (e.g., multiplexers that are inserting CA or other information in the stream) re-creating the PCR and Program Presentation Timestamps (PTS) to account for the amount and location of the added data during a re-multiplexing process. Re-creating the PCR/PTS uses a real time clock as well as dedicated hardware capable of re-encoding multiple MPEG-2 streams in real time. Such hardware (multiplexers) however, is not always available, and adds significantly to the cost of the overall CA implementation.

Another approach to applying the PCR correction involves a software-only solution which is employed to correct only the PCR value by small increments based on the amount of data inserted in the stream. However, software-only PCR correction, in non-real time environment, is prone to the same problem it tries to address, still lacking accuracy in the calculation of the new PCR values. This is increased if PCR values are corrected only and not PTS values, desynchronizing the two.

Alternatively, instead of adjusting the PCR values, NULL packets can be used. NULL packets are data chunks in an MPEG-2 TS that are inserted to correct the bit rate of the stream. The receiver is expected to ignore its contents. Although the replacement of already existing NULL packets in the case of MPEG-2 TS with ECMs or EMMs is a plausible alternative, such replacement needs access to the content encoder or re-encoding the stream to guarantee sufficient bandwidth of NULL packets in the stream. This is a time consuming and complex process that delays the media workflow that is critical, in particular, for live content.

Certain embodiments as disclosed herein provide for avoiding the above-mentioned drawbacks of re-creation, adjustment or using NULL packets for the insertion of auxiliary data. In one embodiment, selected locations of media data are re-formatted to make room in the data section that allows for insertion of auxiliary data without increase in the file size and bit rate. The media data can be identified and reduced in size in an efficient and fast manner, with minimal and imperceptible quality loss, to allow for insertion of auxiliary information without disruption of the stream consistency. In another embodiment, proper PCR values are maintained for the media stream. Benefits of these embodiments include, for example, providing a lightweight process that can be applied in real time in software that has a very limited view of the stream and can therefore be applied with small delay to the video processing workflow. Further, eliminating the frequencies that are expensive to the data compression can result in a reduction in data with minimal amount of visual degradation.

FIG. 3 is a functional block diagram of a system 300 for reformatting selected locations of the media stream to make room in the data section that allows for insertion of auxiliary data without increase in the file size and bit rate. In the illustrated system 300, content is provided from a content server 320 (e.g., by a content owner such as a movie studio) to an operator or distributor (e.g., a head end 310). The head end 310 processes the content, prepares it for distribution, and distributes the content to end users' client devices 340, 342, 344. In one embodiment, a client device is one of desktop computer, a mobile device, and other computing devices such as a tablet device.

A client device is an electronic device that contains a media player. It typically retrieves content from a server via a network but may also play back content from its local storage or physical media such as DVD, Blu-Ray, other optical discs, or USB memory sticks or other storage devices. Examples of client devices include Set Top Boxes, desktop and laptop computers, cell phones, mp3 players, and portable media players.

The content server 320 communicates with the head end 310 by way of a first network 350. The head end 310 communicates with the client devices 340, 342, 344 by way of a second network 360. The networks may be of various types, for example, telco, cable, satellite, and wireless including local area network (LAN) and wide area network (WAN). Furthermore, there may be additional devices between the content server 320 and the head end 310 and between the head end 310 and the client devices 340, 342, 344. The processing at the head end 310 may include encoding of the content if the format provided by the content provider does not meet the operator's requirements. In one embodiment, the processing also includes the addition of auxiliary data before distribution.

In the illustrated embodiment of FIG. 3, the head end 310 includes a network interface module 312 that provides communication. The network interface module 312 includes various elements, for example, according to the type of networks used. The head end 310 also includes a processor module 314 and a storage module 316. The processor module 314 processes communications being received and transmitted by the head end 310. The storage module 316 stores data for use by the processor module 314. The storage module 316 is also used to store computer readable instructions for execution by the processor module 314.

In one embodiment, the system 300 for reformatting selected locations of the media stream includes the head end server 310 and a network interface module 312. The head end server 310 is configured to receive the auxiliary data to be inserted into the media stream through a first network 350. The head end server 310 determines the amount of data in the auxiliary data, identifies media data to be reduced in the media stream, and reformats the media stream to reduce the amount of data in the media data such that the amount of data removed from the media data is at least equal the amount of data in the auxiliary data while providing minimal impact to the quality of the media data. The network interface module 312 is configured to add the auxiliary data to the reformatted media stream and distribute the media stream to a plurality of client devices 340, 342, 344 through a second network 360.

The computer readable instructions can be used by the head end 310 for accomplishing its various functions. In one embodiment, the storage module 316 or parts of the storage module 316 is a non-transitory machine readable medium. For concise explanation, the head end 310 or embodiments of it are described as having certain functionality. It will be appreciated that in some embodiments, this functionality is accomplished by the processor module 314 in conjunction with the storage module 316, and the network interface module 312. Furthermore, in addition to executing instructions, the processor module 314 may include specific purpose hardware to accomplish some functions.

FIG. 4 is a flow diagram illustrating a process 400 of adding auxiliary data to a media stream in accordance with one embodiment of the present invention. In one embodiment, the process 400 is implemented by the head end server 310. At step 410, auxiliary data is determined, read, or received from another component such as a content access system that provides entitlement messages to be inserted. This data also includes the relevant target location in the media stream as a byte location in the stream or time code. The process 400 determines, at step 420, the amount of data that needs to be inserted and the resulting space requirement. The determination is made with the consideration of formatting of packaging the data. The media data to be reduced is then identified, at step 430, to determine whether that media data can be reduced in size according to several specified criteria. For example, the removal should be done with minimal impact to the quality of the stream, be close enough to the target location to be useful, and make enough room for the auxiliary data (“enough room” can be defined as same size or larger than the size of the auxiliary data). The specific approaches and selection of media data to reduce in size are discussed further below. The media data is reduced in size from the media stream, at step 440, by reformatting the media stream, which reduces the media data in size that best suits the requirements. The details of the identification process (step 430) and the reformatting process (step 440) are illustrated in FIG. 5. Auxiliary data is added and adjustment to maintain a consistent media stream is applied, at step 450. In one example, a consistent media stream provides content playback without artifacts such as jitter, skips, or frozen playback. This adjustment, if any, is typically limited to the data between the removed information and the added auxiliary data to correct the values in the stream to accommodate for the removed data until the auxiliary data is included after which the stream has the same timing information as before the process. For example, for a continuous piece of data A (e.g., a bi-directionally predicted frame—‘b’ frame), which consists of many smaller pieces. The data A can be analyzed to remove the least relevant to the final decoded picture quality pieces to produce a new piece of data A′. In this case, the size of A minus the size of A′ is equal or larger to the size of auxiliary data, which can be inserted right after or before the A′. The process 400 continues for all positions of the auxiliary data in the media stream.

As described above, the amount of data in the existing media stream is decreased to create space in the encoded domain. For example, the video stream typically includes system information, audio data, and video data. Since the system information contains very little redundancy and audio data is commonly very small, usually the video data is reduced to accommodate auxiliary data.

In various embodiments, different approaches are used to reduce the size of the video data to accommodate auxiliary data. For example, media data encoded as video using compression formats like MPEG-2 or advanced video coding (AVC) includes different encoding elements that are assembled into the final video during decode. The general approach is either removing those elements or reducing them in size. The decision is made depending on the size that is required to be made available and the impact on the resulting visual quality.

In one embodiment, the approach used is to remove an entire frame. For example, bidirectional (‘b’) frames use information from neighboring frames in both directions but they are not referenced by other frames and are therefore suitable for removal since they do not create artifacts in neighboring frames. The frame may be removed in its entirety, or replaced with instructions that copy the frame from other elements, allowing for storage of this frame with much less data. Depending on the availability of the frames and their content this may create visual artifacts. Other encoding elements that may be removed or replaced with information that is much smaller include slices and macro-blocks, defined in several coding standards. The replacement can occur from neighboring encoding elements.

In another embodiment, elements of frames, slices and macro-blocks are re-encoded using a higher quantization value. Thus, the visual details contained in higher frequencies will be less pronounced but the content can be stored more efficiently, using less data. The elements may be re-encoded individually or may be grouped and reduced in size together, distributing the quality loss over a larger area. Grouping may be more desirable for the resulting loss in visual perception, but it may result in accessing a larger area of the encoded bit stream which creates a more complex process with longer expected delay in the encoding pipeline.

To efficiently exploit temporal redundancy present in video streams compression approaches use several types of frames: I, P and B. Video information of I (intra) and P (predicted) frames may be referenced by other frames that copy part of their visual data. Consequently, any modification by removal of the media data that has an impact on the decoded video information may propagate to other frames. B frames that are not referenced by other frames are the best target for modifications, since those modifications do not propagate to other frames.

A frame encoded as a B frame consists of several key elements including Header data (typically less than 1% of the overall data), motion vector information (typically 1-5%), different flags and adaptive quantization data (typically 1-5%), and variable length code (VLC) discrete cosine transform (DCT) coefficients (˜90%). Thus, the area of interest for data reduction would be the DCT coefficients.

During MPEG-2 encoding, a picture region is divided into 16×16 areas called macro-blocks. Each macro-block is subdivided into several 8×8 areas called blocks. There are between 6 and 12 blocks in a macro-block (depending on the chroma subsampling format). A 2-dimensional DCT is applied to the blocks and then quantization is performed. Quantization is reducing DCT values by an amount depending on their location representing the frequencies. Higher frequencies are often quantized stronger, since they contribute less to the overall perceptual quality of the encoded media data. A useful feature of the encoding process is that usually, at this stage, a majority of coefficients, in particular, in high frequencies are zeros. Higher frequencies are found in the lower right of the 2-D matrix. The resulting 2-D 8×8 matrix is converted into 1-D array by using a zigzag scan and higher frequencies are at the end of this array. The 1-D array is then run length encoded using a Huffman based algorithm that efficiently encodes runs of 0 s.

To reduce the amount of data that is occupied to encode the video and to reduce the media data, the Huffman coding can be undone to arrive at DCT coefficients that can be re-quantized. That is, the quantization table can be applied to further reduce the frequencies for higher compression.

Since the amount of auxiliary data to be stored is often small (e.g. an ECM message of 188 bytes), the modifications to the DCT coefficients can be better targeted by optimizing the selection of targeted areas. The targeted areas are chosen from all areas that can be modified that allows the best tradeoff in reducing the visible impact of data reduction, which allows for more precise targeting of the right amount of data that needs to be removed.

FIG. 5 is a flow diagram illustrating a process 500 that shows the details of the identification process (step 430) and the reformatting process (step 440) in accordance with one embodiment of the present invention. A location of the media data to be modified or removed is identified, at step 510. In this step, a data section within the media data that needs to have additional room (e.g., data or time range in the compressed stream) is determined, for example, by earliest and latest locations of the auxiliary data. The media data to be modified is identified, at step 520. In one embodiment, all blocks in frames that are in the location to be modified are identified. Preferably, blocks contained in B frames or parts thereof are identified. As stated above, B frames include DCT coefficients that can be targeted for data reduction.

The DCT coefficients are generated and sorted by impact on the visual quality, at step 530. For example, the coefficients that are clustered in the high frequencies with high values that use the largest space to encode and contribute relatively little to the visual quality of the encoded picture are sorted. The sorting criterion can be the weighted sum of the DCT values, with more weight given to the DCT values corresponding to the higher frequencies.

At step 540, the coefficients with the largest values of the sorted list are removed and the coefficients corresponding to the highest frequencies are set to zero, which allows for compression to smaller size data during the Huffman encoding. The process 500 continues at step 550 by applying Huffman encoding which re-encodes the modified block of blocks. The size of the unmodified block is compared, at step 560, with the modified block to determine the amount of media data that has been removed. If the difference (i.e., the size of the media data removed) is determined, at step 570, to be not yet large enough (i.e., the difference is smaller than the amount of auxiliary data), the process 500 continues back to step 540. For example, given how many bytes should be made available at a certain frame interval, several passes can be applied until at least that amount of data is reduced from the encoded frames in the specified interval. Otherwise, the process 500 of removing the media data is complete.

In one embodiment, the media data is removed from macro-blocks. In another embodiment, the removed media data is prediction information of the macro-blocks. As stated above, the auxiliary data can include digital right management (DRM) information, which can include MPEG-2 entitlement management messages and entitlement control messages. In yet another embodiment, the media stream is in a streaming media format. In a further embodiment, the streaming media format is an MPEG-2 transport stream.

The foregoing approach can target combinations that are encoded using an escape signal Huffman code followed by raw representation of that pair, which is used to preserve high frequencies but is generally expensive in terms of data usage. The escape code sequences commonly encode noise present in the original or high frequency patterns. Such processes are generally not used by MPEG-2 encoders or systems that recompress the content and may not optimize DCT coefficients after quantization to fit with the Huffman table. Thus, the combinations often take significant number of bits to encode but contribute a comparably small amount to the resulting video quality.

Another approach could be a rate distortion optimization (RDO) function recalculation based on macroblock data replacement. For example, an estimate distortion cost for each macroblock is skipped and then macroblocks with the lowest distortion cost are also skipped until the requested amount of bit saving is reached. Thus, when the skipped mode as well as forward and/or backward copy are not taken into account, the 16×16 mode is split to 16×8/8×16 or even further (AVC applicable only). Further, the more complicated the process of RDO recalculation, the less visual impact it is for the same amount of bits saved.

Areas of application where additional auxiliary information is inserted in the stream after it has been formatted include DRM application where the content will to be encrypted and additional data for authentication and decryption is useful. This may be from a single or first DRM system or from additional DRM systems that aim to include support for additional devices that only support the secondary DRM system. Another example includes copy control information that supplies information about how the content can be used, what the allowed outputs are, and how often a user may make a copy. Other areas include information that enhances the content and consumption such as subtitles or additional audio tracks that are later added to the stream, and information for a video decoder or video renderer that enables more efficient decoding but are proprietary to a single decoder or thumbnails that are added to be displayed with the content. Another example of data that may later be added to the content is Internet links to websites with related information.

The foregoing systems and methods and associated devices and modules are susceptible to many variations. Additionally, for clear and brief description, many descriptions of the systems and methods have been simplified. Many descriptions use terminology and structures of specific standards. However, the disclosed systems and methods are more broadly applicable.

Those of skill in the art will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular constraints imposed on the overall system. Skilled persons can implement the described functionality in varying ways for each particular system, but such implementation decisions should not be interpreted as causing a departure from the scope of the invention. In addition, the grouping of functions within a unit, module, block, or step is for ease of description. Specific functions or steps can be moved from one unit, module, or block without departing from the invention.

The various illustrative logical blocks, units, steps, components, and modules described in connection with the embodiments disclosed herein can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC. Additionally, device, blocks, or modules that are described as coupled may be coupled via intermediary device, blocks, or modules. Similarly, a first device may be described a transmitting data to (or receiving from) a second device when there are intermediary devices that couple the first and second device and also when the first device is unaware of the ultimate destination of the data.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter that is broadly contemplated by the present invention. It is further understood that the scope of the present invention fully encompasses other embodiments that may become obvious to those skilled in the art and that the scope of the present invention is accordingly limited by nothing other than the appended claims.

1. A method to reformat a media stream to include auxiliary data, the method comprising:
receiving the auxiliary data to be inserted into the media stream;
determining the amount of data in the auxiliary data;
identifying media data in the media stream to be reduced in size;
reformatting the media stream to reduce the amount of data in the media data such that the amount of data removed from the media data is at least equal to the amount of data in the auxiliary data while providing minimal impact to the quality of the media data; and
adding the auxiliary data to the media stream which maintains a consistent size.

2. The method of claim 1, wherein the auxiliary data includes a target location in the media stream as a byte location in the media stream to indicate a location for an insertion of an entitlement control message (ECM).

3. The method of claim 1, further comprising
applying adjustment to maintain consistency in the media stream,
wherein the adjustment is made to data between the removed media data and the added auxiliary data.

4. The method of claim 3, wherein the consistency in the media stream provides playback of the media data without artifacts including jitter, skips, and frozen playback.

5. The method of claim 1, wherein the removed media data is video data, and
wherein reformatting the media stream to reduce the amount of data in the media data comprises
removing an entire B frame of the video data.

6. The method of claim 1, wherein reformatting the media stream to reduce the amount of data in the media data comprises
re-encoding elements of at least one of frames, slices and macro-blocks using a higher quantization value.

7. The method of claim 6, wherein the elements are re-encoded in groups to distribute a quality loss over a larger area.

8. The method of claim 1, further comprising
identifying a location of the media data to be removed by earliest and latest locations of the auxiliary data, and identifying blocks in frames that are in the location of the media data to be removed.

9. The method of claim 8, wherein reformatting the media stream comprises
generating and sorting DCT coefficients of the blocks in the frames by impact on visual quality of the media data to produce a sorted list; and
removing the DCT coefficients with largest values in the sorted list that would remove enough data from the media data to accommodate the amount of data in the auxiliary data.

10. The method of claim 9, further comprising
setting the DCT coefficients corresponding to highest frequencies to zero; and
applying Huffman encoding to re-encode the blocks.

11. The method of claim 1, wherein the removed media data is encoded in macro-blocks with prediction information.

12. The method of claim 1, wherein the auxiliary data includes digital right management (DRM) information.

13. The method of claim 12, wherein the DRM information includes
MPEG-2 entitlement management messages and entitlement control messages.

14. The method of claim 1, wherein the media stream is in an MPEG-2 transport stream format.

15. A system for reformatting a media stream to include auxiliary data, the system comprising:
a head end server configured to receive the auxiliary data to be inserted into the media stream through a first network, the head end server determining the amount of data in the auxiliary data, identifying media data to be reduced in size in the media stream, and reformatting the media stream to reduce the amount of data in the media data such that the amount of data removed from the media data is at least equal the amount of data in the auxiliary data while providing minimal impact to the quality of the media data; and
a network interface module configured to add the auxiliary data to the reformatted media stream and distribute the media stream to a plurality of client devices through a second network while the media stream maintains a consistent size.

16. The system of claim 15, wherein the auxiliary data includes digital right management (DRM) information.

17. A non-transitory storage medium storing a computer program to reformat a media stream to include auxiliary data, the computer program comprising executable instructions which cause the computer to:
receive the auxiliary data to be inserted into the media stream;
determine the amount of data in the auxiliary data;
identify media data to be reduced in size;
reformat the media stream to reduce the amount of data in the media data such that the amount of data removed from the media data is at least equal to the amount of data in the auxiliary data while providing minimal impact to the quality of the media data; and
add the auxiliary data to the media stream which maintains a consistent size.

18. The non-transitory storage medium of claim 17, wherein executable instructions that cause the computer to identify media data to be removed comprise executable instructions which cause the computer to
identify blocks in frames that are in a location of the media data to be removed.

19. The non-transitory storage medium of claim 17, wherein executable instructions that cause the computer to reformat the media stream comprise executable instructions which cause the computer to
generate and sort DCT coefficients of the blocks in the frames by impact on visual quality of the media data to produce a sorted list; and
remove the DCT coefficients with largest values in the sorted list that would remove enough data from the media data to accommodate the amount of data in the auxiliary data.

20. The non-transitory storage medium of claim 19, further comprising executable instructions which cause the computer to
set the DCT coefficients corresponding to highest frequencies to zero; and
apply Huffman encoding to re-encode the blocks.
